(19) United States
(12) Patent Application Publication
(10) Pub. No.: US 2018/0167355 A1
(43) Pub. Date: Jun. 14, 2018

(54) APPARATUS, METHOD AND SYSTEM FOR SECURE NETWORK ACCESS WITH VARIABLE IDENTITY

(71) Applicant: GLOBETOUCH, INC., Oakland, CA (US)

(72) Inventor: Seppo KERONEN, HELSINKI (FI)

(21) Appl. No.: 15/376,010

(22) Filed: Dec. 12, 2016

(51) Int. Cl. H04L 29/12; H04L 12/66; H04L 12/46

(52) U.S. Cl. CPC H04L 61/2007; H04L 12/4641; H04L 61/1511; H04L 12/66

(57) ABSTRACT

A system and method of creating multiple network identities which allow control of the aspect, extent, and details of identity and associated information of a network enabled device user, visible to online service providers, peer devices, or other correspondents or to third parties intercepting network traffic.

### BACKGROUND

Modern packet communications networks provide the infrastructure for an increasing number and variety of services. Such state-of-the-art internet and intranet infrastructure is able to connect a client-device with any of a vast number of correspondent devices (including server devices and peer client-devices).

The end-to-end communications path between corresponding terminal devices typically passes through a number of intermediate network devices. Network devices, both terminal- and intermediate-, may be referred to as “network nodes” or just as “nodes”.

Typical packet communications networks require that terminal devices be provisioned with routable network addresses to facilitate the identification of the terminal device and determination of a network path for the transmission of data packets. Popular addressing mechanisms include Ethernet and internet protocol (IPv4 and IPv6) addressing.

Routable Internet protocol addresses are assigned by hierarchical organizations in blocks (subnets) each containing a range of addresses. These subnets are assigned to devices in close proximity to each other. Proximity is in terms of network path distance, administrative domain, and geographic location. Network routing is facilitated by maintaining the assignment of addresses to devices in a manner that is relatively stable over time. These factors make it feasible for observers of network traffic to attribute features like identity, geographic and organizational location, and behavior over time to terminal devices.

Both legal and illegal interception devices are commonly deployed in networks to inspect, analyze, store, and act on data communications packets. In the case that the payload of a packet is in plain-text, deep packet inspection (DPI) methods are used to extract and analyze transmitted data. Increasingly however the payload of transmitted packets is encrypted, leaving just the source and destination IP addresses to identify the corresponding parties. Even this meta-data reveals much about the activities, interests, and attitudes of network users.

Methods to disguise IP addresses are known practices. Network address translation (NAT) is commonly used by intranet gateways to hide private intranet addresses and conserve limited IPv4 address space. Onion routing and networks of co-operating routers, such as the Tor network for example, are used to disguise the identity of correspondents by encapsulate messages in layers of encryption.

Current practice to authenticate and authorize access to online content and services relies on presentation of credentials (such as user-names, passwords and one-time tokens). Credentials are presented explicitly by the user—or on behalf of the user—by a password manager or single-sign-on service provider. It is a goal to have the convenience of single-sign-on mechanisms, but with significantly better efficiency and less complexity of setup and operation than present methods.

### SUMMARY

The present disclosure details the construction of a novel intermediate device—referred herein as “gateway-device”. The term “client-device” refers to a terminal device that an individual user employs to gain access to network services via the gateway-device. Examples include personal computers, tablets, smart phones, and similar consumer and custom devices.

Examples herein are described in terms of the internet protocol (IP), but they also apply to other similar network addressing mechanisms.

The present disclosure presents systems and methods to overcome the shortcomings of present methods used to control the visibility of identity and related information available to service providers and interceptors. To this end, systems and methods for users operating a client-device to select routable IP addresses with appropriate identity attribution, traceability, and information associated with an identity is provided herein. In the case that more than one address is selected, they are made available for concurrent use. This provides an improvement on existing virtual private network (VPN) and other such products that allocate just one routable address for use at any one time.

In a first aspect of the invention, a network address assignment system is described, comprising: a client-device address allocation system residing on a client-device, the client-device address allocation system comprising: a client-device application processor module, a client-device communications processor module, and a client-device persistent memory module; and a gateway-device address allocation system residing on a gateway-device, the gateway-device address allocation system comprising: a gateway-device application processor module, a gateway-device communications processor module, and a gateway-device persistent memory module, wherein the client-device address allocation system is configured to allocate network addresses to be used by the gateway-device for network traffic to and from the client-device.

One skilled in the art can envision further aspects given the disclosure herein.

### BRIEF DESCRIPTION OF DRAWINGS

FIG. 1 shows an example overview of a user being provided different address types through a gateway-device in order to access various services connected by a network.

FIG. 2 shows an example of multiple users and multiple client-devices utilizing a common gateway-device.

FIG. 3 shows an example block diagram of the systems in a client-device and gateway-device, including a network interface context in the client-device.

FIG. 4 shows an example block diagram of the client device- and gateway-device including secure communication utilizing a secure element.

FIG. 5 shows an example block diagram of the network address allocation systems, utilizing distributed application processing, of the client-device and gateway-device.

FIG. 6 shows an example of application processing by the network address allocation systems.

FIGS. 7A-7C show example user interface entries for the address allocation system.

FIG. 8 shows an example embodiment of a target hardware for implementing the embodiments herein.

### DETAILED DESCRIPTION

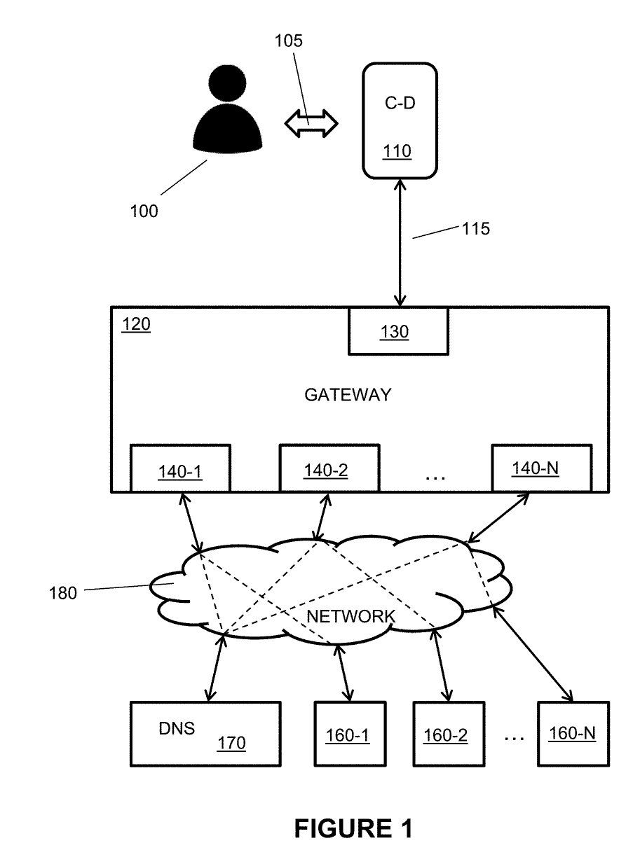

An exemplary top-level structure of the system, consisting of client-device and gateway-device apparatus, and its operating environment is illustrated in FIG. 1.

A user (100) operates a client-device (110). The interaction can be authenticated (105) such that any unauthorized user is not permitted to operate the client-device. Authenticated interaction means include: biometric assisted methods such as fingerprint, voice print, iris pattern recognition and so on; token based methods including RFID tokens, token generating devices, printed cards with one-time tokens, and similar methods.

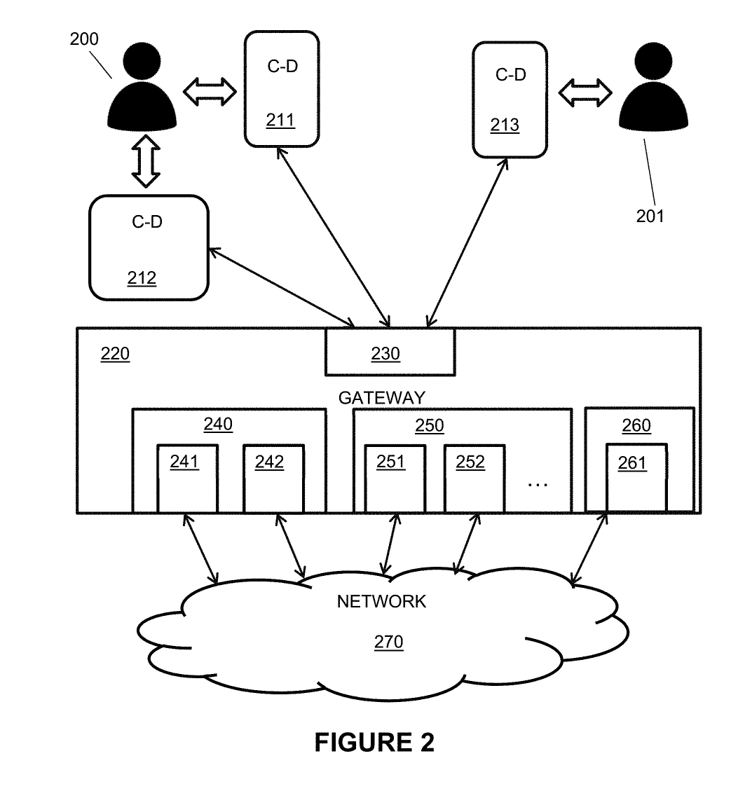

The client-device (110) communicates with a personal gateway device (120) via an access address (130). This communication link can be secured by means of secure sockets layer (SSL), IPSec, or other public or private key encrypted protocol. The access address (130) can be a single public static address or it may be an address that changes over time to make tracking of the user more difficult. The access address can be shared by multiple users, as illustrated in FIG. 2, to prevent tracing and attribution of traffic to any single individual. The client and gateway devices can also inject extra packet traffic to make attribution more difficult.

The client-device (110) actively notifies the gateway (120) whenever the client-device (110) acquires a new (temporary) address, enabling the gateway (120) to reach the client-device (110) whenever it has data packets to forward to it. The payload of each packet exchanged by the client-device (110) and gateway (120) can be encrypted, salted, and/or digitally signed to maintain integrity and privacy.

The personal gateway (120) routes data packets from the access address (130) to one of a number of external addresses (140-1, 140-2, . . . , 140-N), as well as in the reverse direction. The gateway (120) may consist of a single device or a network of devices connected by a secure packet communication means. Secured packet communication means include secure sockets layer (SSL), IPSec, or other public or private key encrypted protocol. Thus, the routing function may be carried out within a single device that presents a number of external addresses or it may be carried out within a network of devices, such as a network cloud service.

It is instructive to view the client-device (110) and gateway-device (120) as a single composite virtual device that presents a number of external addresses (140-1, 140-2, . . . , 140-N) through which it provides access to various online network services (160-1, 160-2, . . . , 160-N) and any desired network facilities, such as a domain name service DNS (170). Typically the gateway-device (120) has a static location within the packet network infrastructure (e.g. a server), while the client-device is mobile (e.g. a smart phone or wi-fi device). In this sense, an external service does not need to track the mobile device, but rather communicates via a static address provided by the gateway.

The external addresses (140-1, 140-2, . . . , 140-N) can each possess a number of special characteristics, such as the following:
Named/Unnamed: An address may be associated with a name, such as a domain name as presently used on the internet. The name will typically reflect the identity, organizational affiliation, geographic location, responsibility role or competence and so on of the person or other entity being addressed.
Public/Private: The association between a name and address may or may not be published by a name or directory service, such as the domain name service (DNS) on the internet or an LDAP directory on an intranet.
Verified/Unverified: The name-address association may be verifiable by being listed in a trusted name or directory service, by trusted certificate, trusted referral by public/private key challenge or other trusted certification means.
Persistent/Volatile: The address may persist as valid and operational for a long period of time, or it may change frequently, often in an unpredictable manner to prevent tracking of activity over time. Preferably persistent addresses are reserved for extended periods of time and re-use for other purposes is not permitted, thereby reducing the need to frequently verify that the association has not expired.
Reachable/Unreachable: For connection oriented protocols, the address may respond to an externally initiated connection or it may ignore such connection attempts.

Making reference to the above attributes, the external addresses (140-1, 140-2, . . . , 140-N) can also be categorized. The following are examples of such categories:
Personal Address: This is a named, verifiable, persistent address that is associated with the real name of an individual or other entity. This can provide a verifiable address for services that require user verification, such as banking.
Role Address: This is a named, verifiable, persistent address associated with persons or entities responsible to carry out duties of the named role. Examples of such roles are an editor, a president, duty physician and so on. This allows a Role Address to persist as static as different people take the role over time.
Personality Address: This is a named, public, persistent address that is associated with a pseudonym, pen-name, alias, or other such name that is associated with an individual or group. Multiple personality addresses may well be associated with a single individual or organization. This allows a user to present a consistent identity for a service, such as an on-line blog or message board, without revealing the real identity of the user.
Anonymous Address: This is an unnamed, volatile address. This is used to provide anonymity to the user.

FIG. 2 illustrates an example extension of the system, where a single user (200) operates multiple client-devices (211 and 212) and multiple users (200 and 201) employ the same gateway instance (230). In this case, the gateway-device (220) maintains a set of external interfaces (240) for each individual and a common set of interfaces (250) for anonymous addresses, as well as a set of personality interfaces (260), for access to the network (270). Other addressing types can also be included. The user (200) with multiple client-devices (211 and 212) can be provided different address types for the different client-devices (for example, one personal address and one personality address), or they can share the same address type, but with different addresses (for example, two anonymous address).

Suppose that one user (200) has established a verified and personality address with the system, and the other user (201) only has a verified address established. Then the first user (200) would have their traffic routed by a verified address (241) and a personality address (261). The second user would only have a verified address (242) usable for non-anonymous (or semi-anonymous, if the personality is an anonymous pseudonym) routing. Both users (200, 201) can also access a shared pool of anonymous addresses (251, 252, . . . , etc.) for anonymous access to the network (270).

Even individual-user-only systems can employ a shared pool of anonymous external addresses for that user, to allow greater anonymity in addressing.

### Communication Data Flow

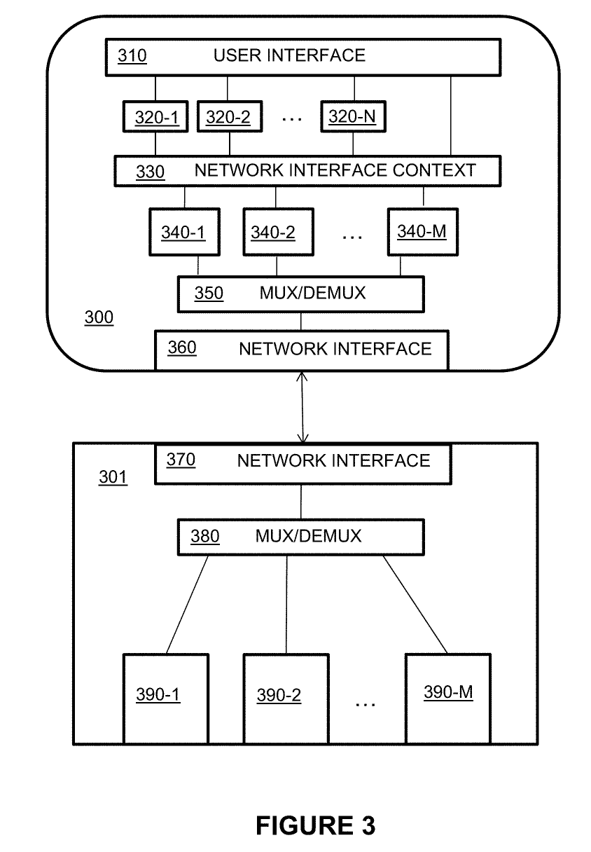

The functional structure to realize the communication data flow of the invention is shown in FIG. 3. The client-device (300) hosts a number of applications (320-1, 320-2, . . . , 320-N) accessible through the client-device's user interface (310). Applications can include an unmodified smartphone, a tablet, a wearable device (such as a smart watch or a mixed reality headset), a connected car, and other terminal device applications. Examples of such applications include social network client applications, web browsing applications, and web pages that include application logic.

The set of external interfaces (390-1, 390-2, . . . , 390-M) for the gateway-device (301) are reflected on a client-device (300) as virtual network interfaces (340-1, 340-2, . . . , 340-M).

Each application is provided a filtered set of available virtual network interfaces. The filtering is performed by the Network Interface Context (330). An available external interface is selected by the user of the client-device (300) by means of an interface (310). Any non-selected virtual network interfaces can be hidden and made not available for use by the application. The Network Interface Context (330) can select the appropriate external interface address type to use on a case-by-case basis based on pre-set rules or user selection, or the application can be built to make the selection based on its own set of rules (for example, a credit card application selecting a verified personal address).

Alternatively, client-device applications may be provided with an application programming interface (API) or other suitable means to access more than one virtual network interface and hence utilize multiple external interfaces at the same time.

The one-to-one link between client side virtual network interfaces (340-1 et al.) and gateway side external interfaces (390-1 et al.) can be provided by a multiplex/demultiplex structure (350 and 380). The two MUX/DEMUX blocks (350 and 380) exchange network packets annotated with the identity of the selected external network interface (e.g. 390-1). The annotation may be achieved by an encapsulation (tunneling) protocol or by marking packet header fields or payload. For example, an IPv6 extension header containing an index of the selected external interface may be used to identify the desired interface.

### Security

The protocol used to multiplex traffic between a client-device and gateway-device can encrypt the annotation and any plain-text data. The protocol can also authenticate both ends of the connection and can include salted time-stamps, or other such mutually agreed mechanism, to protect against man-in-the-middle replay and denial-of-service attacks. Multiple options for such protocols are available, including tunneling protocols, such as secure shell (SSH) tunneling and IPSec, for example.

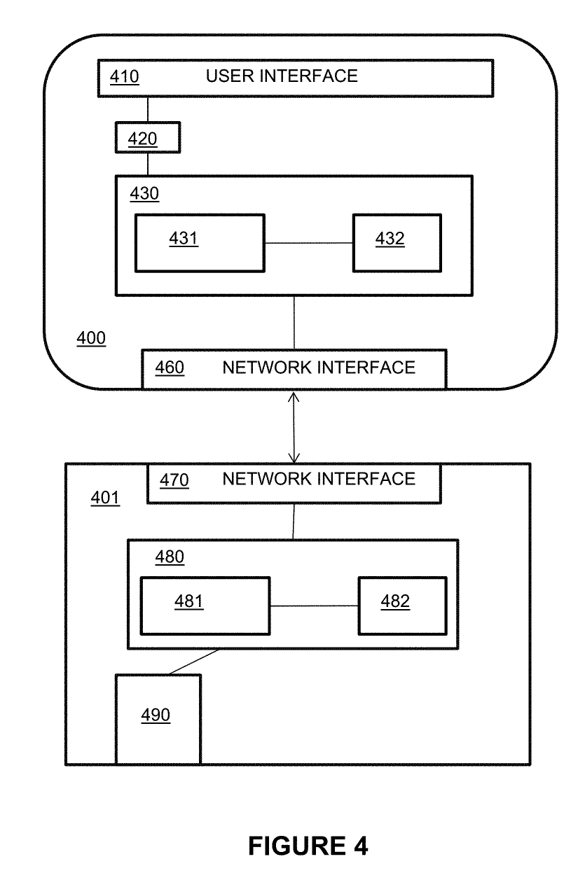

Abstracting the communications functions described above as a client-communications-processor (430) and a gateway-communications-processor (480) is shown in the example of FIG. 4. These processors incorporate the client virtual network interfaces and multiplex/demultiplex functions described in FIG. 3. As shown in FIG. 4, these processors can also incorporate security processing (431 and 481) of the forward and reverse streams of data packets exchanged by the client-device (400) and gateway-device (401) for an application (420), through the network interfaces (460 and 470).

Both the client- and gateway-devices can incorporate a secure element (432 and 482) that contains a private key and associated decryption logic to enable the mutual authentication of the client-device (400) and gateway-device (401). Secure communications with external entities via the external network address (490) may employ either of these secure elements as follows:
Client Secure Element: In the case that the gateway-device is not sufficiently trusted, it is preferred that end-to-end encryption of communications is employed.
Gateway Secure Element: In the case that the gateway-device is sufficiently trusted, it is preferred that the gateway-device secure element is employed to enable handover of a session from one client-device to another and more flexible use of multiple client-devices.
Selectable Secure Element: Optionally a client user interaction affordance may be provided to allow the user to select which secure element is in use.

### Application Processors

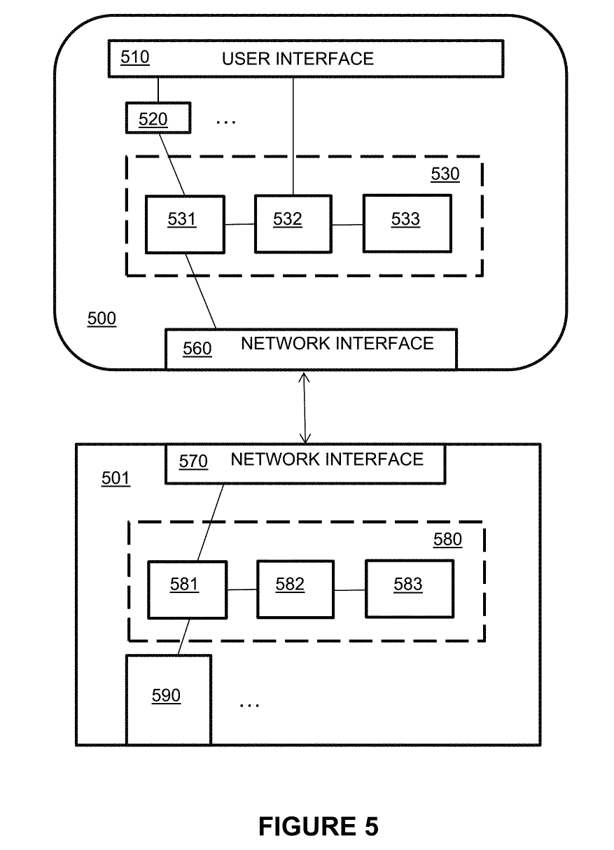

Optionally, as illustrated in FIG. 5, the client-device (500) and gateway-device (501) can each incorporate an application processor, client-side (532) and gateway-side (582), and associated persistent memory storage (533 and 583). An application processor (532, 582) can consist of a runtime for one or more programming languages and an application programming interface (API) to the corresponding communications processors (531 and 581) and to the client user interface (510). The communication processors (531 and 581) communicate through the network interfaces (560 and 570) and out to a network through an external network interface (590). The client-device application processor (532), persistent memory storage (533), and communications processor (531) can be seen packaged as a client-device address allocation system (530). The gateway-device application processor (582), persistent memory storage (583), and communications processor (581) can be seen packaged as a gateway-device address allocation system (580).

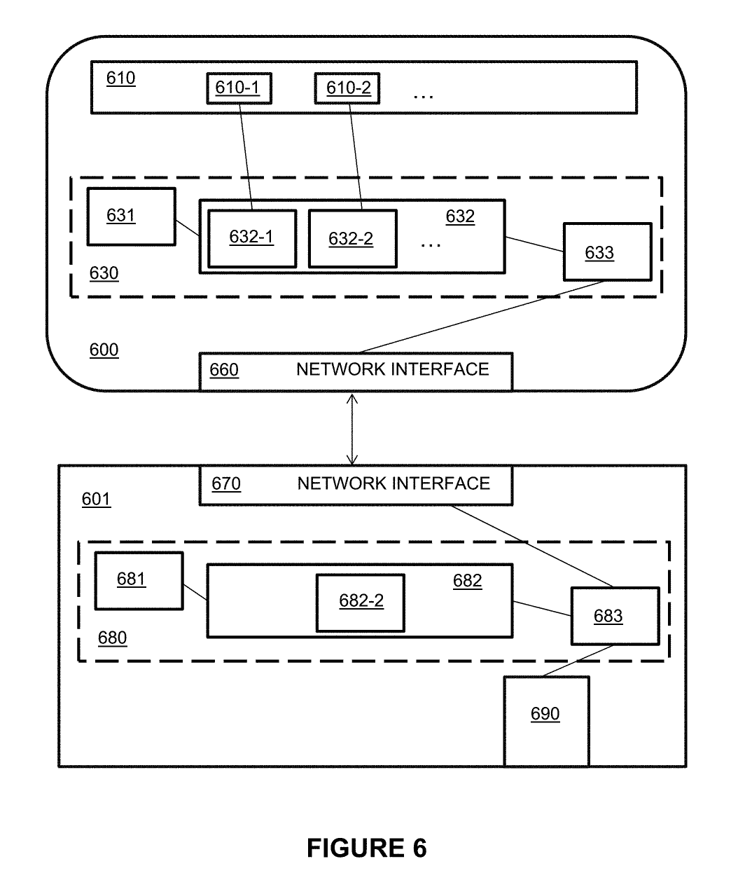

Applications execute on either the client or gateway application processor individually, or as a composite application that has co-operating components on both processors. If the application is to be accessed by outside services, such as a user setting up a blog to be read by other, external, users, the blog application can be established on the gateway-device. FIG. 6 illustrates a system with two applications: one application (632-1) is a single component application that executes on the client processor (632); the other application consists of two components (632-2 and 682-2) executed between the client processor (630) and gateway processor (680). The two components communicate via an inter-process communication API, such as remote procedure calls, messaging, shared blackboard, and the like.

Each application can have a corresponding user interface (610-1 and 610-2) as part of the general client-device user interface (610). Also shown in FIG. 6 are the persistent memory storage (631 and 681), the communication processors (633 and 683), and the network interfaces (660, 670, and 690).

### Example 1

Table 1 shows a typical application that executes primarily on the gateway application processor, according to the specification in “Gateway Information Service Database”, and employs a client application processor for user interaction. The application is an instance of the same two component structure of the second application (632-2 and 682-2) as shown in FIG. 6. A user can input the relevant data through a user interface on the client-device.

TABLE 1
Gateway Information Service Database

| Data Type | Data | | | | |
|---|---|---|---|---|---|
| Object Data: | address1 | street-address | “1 Baker Street, London, UK” | | |
| Meta Data: | address1 | valid-end | “23 august 2017” | | |
| Deonitic Data: | street-address | yes | 2.7.2017 12:37 | 8 hrs | go.acme.com |

| | | | | |
|---|---|---|---|---|
| Access Data: | street-address | read | 2.7.2017 12:38 | go.acme.com |

The illustrative example in Table 1 employs an external network interface associated with an individual person named “Charles Dodgson”, as published by a domain name service (DNS) record shown in Table 2.

TABLE 2
DNS Entry

| | | |
|---|---|---|
| charles.dodgson.idv.uk. | aaaa | 2001:db8:a0b:12f0::1 |

In the example, Charles wants to provide a delivery service, having a source DNS address at “go.acme.com”, access to his real-world street address so that they can deliver a package to him. The Service Database can be set up to let delivery service, and only the delivery service, look up his street address by pinging Charles' DNS listed address, and only during a certain window of time. The Object Data provided for the IP address (address1) is Charles Dodgson's street address, at 1 Baker Street. The Access Data provides a log that the street address was “read” by service “go.acme.com” at the provided timestamp date and time. The service “go.acme.com” has, as provided in the Deonitic Data, an 8 hour window to access the street address after the timestamp provided in that entry (i.e. from 12:37 on Jul. 2, 2017). The Meta Data sets date when the Object Data is no longer valid (“valid-end”, on Aug. 23, 2017).

### Example 2

Table 3 shows a typical application that executes primarily on the gateway application processor, according to the specification in “Gateway Information Service Database”, and employs a client application processor for user interaction. The application is an instance of the same two component structure of the second application (632-2 and 682-2) as shown in FIG. 6. A user can input the relevant data through a user interface on the client-device.

TABLE 3
Gateway Information Service Database

| Data Type | Data | | | | |
|---|---|---|---|---|---|
| Object Data: | address2 | phone-number | “1-800-555-1212” | | |
| Meta Data: | address2 | valid-end | “21 June 2017” | | |
| Deonitic Data: | phone-number | yes | 1.6.2017 13:17 | 2 days | <any> |

| | | | | |
|---|---|---|---|---|
| Access Data: | phone-number | read | 2.6.2017 15:28 | hostserv.org |

The illustrative example in Table 3 employs an external network interface associated with an organization named “MegaPix”, as published by a domain name service (DNS) record shown in Table 2.

TABLE 4
DNS Entry

| | | |
|---|---|---|
| megapix.idv.uk. | aaaa | 2001:ef9:a1c:14f0::1 |

In the example, MegaPix wants to provide everyone (designated with the wildcard <any> in this example), access to their real-world phone number so that they can call in for a two-day contest. The Service Database can be set up to let anyone look up their phone number by pinging MegaPix's DNS listed address, but only during a certain window of time. The Object Data provided for the IP address (address2) is MegaPix's call-in number, 1-800-555-1212. The Access Data provides a log that the phone number was “read” by service “hostserv.org” at the provided timestamp date and time. The people wanted to call in have, as provided in the Deonitic Data, a 2 day (48 hour) window to access the phone number after the timestamp provided in that entry (i.e. from Jun. 1, 2017 at 12:37). The Meta Data sets date when the Object Data is no longer valid (“valid-end”, on Jun. 21, 2017).

Other forms of Object Data can be used, with other permissions and logs being imagined, as needed by the user.

The aforementioned sample application responds to HTTPS requests addressed to the external network interface. A gateway information service database is constructed to specify what information is returned in response to which URL. Preferably this database also specifies the meta-data aspect, such as period of validity, of the information. Preferably the database also specifies the deontic aspect, such as who is able to access or modify the data. Preferably the information service also maintains records of access attempts of the data for analysis, non-repudiation and such purposes.

### Example Embodiment

The global Internet is in a transition from an earlier version of the internet protocol (IPv4) to a more recent version (IPv6). The present invention is deployed to take advantage of the increased availability of IPv6 addresses compared to the shortage of IPv4 addresses.

This embodiment provides a user with multiple static IP addresses. One of the addresses is published by DNS, and is verifiable using a certificate available via an information service and a private key retained by a gateway secure element, as illustrated in FIG. 4. A pool of individually allocated pseudonym IP addresses and a shared pool of anonymous IP addresses can be maintained and made available, as shown in FIG. 2, for configuration by an interface, as illustrated in FIG. 3.

The gateway-device is typically embodied as a rack server maintained in a secure data center located as part of the Internet backbone infrastructure. The client-device is constructed as an enhancement of a mobile terminal device, typically a smartphone, tablet or laptop form-factor. The communication path between the client and gateway devices is implemented as a secure tunnel using a selectable tunneling protocol, including IPSec and OpenVPN.

Both the client application processor (610) and gateway application processor (660) are node.js Javascript/ECMSscript runtimes. Persistent storage is provided by the node.js file-system API. The nodejs network communications API is extended to include an external interface selector function. The client and gateway components are inter-connected by means of the node.js child process APIs. A number of embodiments of the disclosure have been described. Nevertheless, it will be understood that various modifications may be made without departing from the spirit and scope of the present disclosure. Accordingly, other embodiments are within the scope of the following claims.

### User Interaction

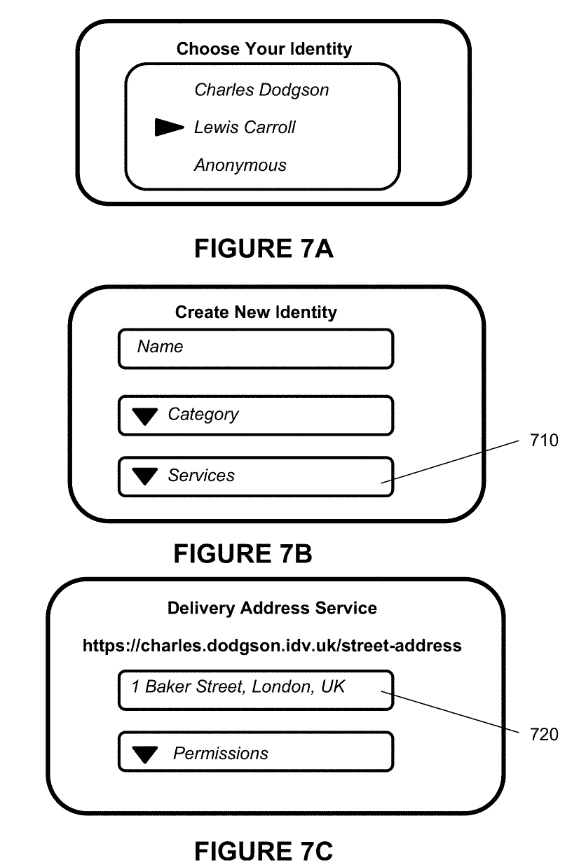

The user interaction aspect of the system is illustrated in FIGS. 7A-C. The operation of the system can be integrated as a part of the operating environment of a client-device. The interaction may take the form of a graphical user interface or as a hands-free audio interface or other such convenient form of user input.

The user is provided with an interaction means, such as shown in FIG. 7A, to select one of the available external addresses (“identities”) to be used. Such selection is available separately in the context of each user application. In this way the user is able to engage in a conference call via a named and verified “work” address, and at the same time browse for competitor information via an anonymous interface, for example.

The user is also provided with a means to create, modify and delete an external address. A graphical interface means to achieve this is illustrated in FIG. 7B. The user can specify a name to be associated and published. In the case that the external addresses are divided into categories, the user can select a category, such as “pen name” or “professional role” for example. The downward pointing triangle indicates a selection option for the field, where the box expands with multiple options to select from.

As a further aspect of the invention, the user can select services to be associated with a chosen external address. As an example, illustrated in FIG. 7B, the user may choose a “street address service” from the services selector (710) and configure the service as illustrated in FIG. 7C. This example service simply responds with the text entered in the “Address Text” field (720) in response to a HTTPS GET request at the URL specified above that text. The services aspect of the invention is described in more detail subsequently.

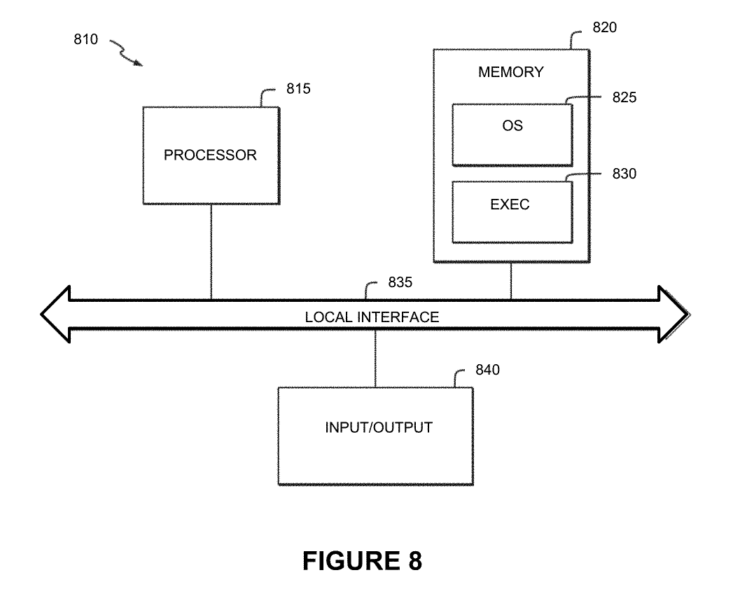

FIG. 8 is an exemplary embodiment of a target hardware (810) (e.g., a computer system) for implementing the embodiment of FIGS. 1 to 7C. This target hardware comprises a processor (815), a memory bank (820), a local interface bus (835) and one or more Input/Output devices (840). The processor may execute one or more instructions related to the implementation of FIGS. 1 to 7C and as provided by the Operating System (825) based on some executable program (830) stored in the memory (820). These instructions are carried to the processor (815) via the local interface (835) and as dictated by some data interface protocol specific to the local interface and the processor (815). It should be noted that the local interface (835) is a symbolic representation of several elements such as controllers, buffers (caches), drivers, repeaters and receivers that are generally directed at providing address, control, and/or data connections between multiple elements of a processor based system. In some embodiments the processor (815) may be fitted with some local memory (cache) where it can store some of the instructions to be performed for some added execution speed. Execution of the instructions by the processor may require usage of some input/output device (840), such as inputting data from a file stored on a hard disk, inputting commands from a keyboard, inputting data and/or commands from a touchscreen, outputting data to a display, or outputting data to a USB flash drive. In some embodiments, the operating system (825) facilitates these tasks by being the central element to gathering the various data and instructions required for the execution of the program and provide these to the microprocessor. In some embodiments the operating system may not exist, and all the tasks are under direct control of the processor (815), although the basic architecture of the target hardware device (810) will remain the same as depicted in FIG. 8. In some embodiments a plurality of processors may be used in a parallel configuration for added execution speed. In such a case, the executable program may be specifically tailored to a parallel execution. Also, in some embodiments the processor (815) may execute part of the implementation of FIGS. 1 to 7C and some other part may be implemented using dedicated hardware/firmware placed at an Input/Output location accessible by the target hardware (810) via local interface (835). The target hardware (10) may include a plurality of executable programs (830), wherein each may run independently or in combination with one another.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A network address assignment system, comprising:
a client-device address allocation system residing on a client-device, the client-device address allocation system comprising:
a client-device application processor module,
a client-device communications processor module, and
a client-device persistent memory module; and
a gateway-device address allocation system residing on a gateway-device, the gateway-device address allocation system comprising:
a gateway-device application processor module,
a gateway-device communications processor module, and
a gateway-device persistent memory module,
wherein the client-device address allocation system is configured to allocate network addresses to be used by the gateway-device for network traffic to and from the client-device.

2. The system of claim 1, wherein the network address to be used are selected from a pool of network address categories comprising at least one of: personal address, role address, personality address, and anonymous address.

3. The system of claim 1, wherein the client-device application processor module is configured to be controlled by a user interface on the client-device.

4. The system of claim 1, wherein the gateway-device address allocation system is capable of handling address allocation for multiple users at the same time.

5. The system of claim 4, wherein the network address to be used are allocated from a pool of network addresses that include a plurality of anonymous addresses.

6. The system of claim 1, wherein the gateway-device address allocation system is capable of allocating addresses to multiple client-devices for a given user at the same time.

7. The system of claim 1, further comprising client-device virtual network interfaces in the client-device address allocation system, where the client-device virtual network interfaces correspond to external network interfaces on the gateway-device.

8. The system of claim 1, wherein the client-device application processor module and the gateway-device application processor module are configured so that an application service runs partially on the client-device application processor module and partially on the gateway-device application processor module.

9. The system of claim 1, wherein the client-device address allocation system further comprises a network interface context.

10. The system of claim 9, wherein the network interface context is configured to be controlled by a user interface on the client-device.

11. The system of claim 1, further comprising encryption between the client-device address allocation system and the gateway-device address allocation system.

12. The system of claim 11, wherein the encryption comprises a secure element.
